(19) United States
(12) Patent Application Publication
(10) Pub. No.: US 2014/0272739 A1
(43) Pub. Date: Sep. 18, 2014

(54) FLARE STACK WITH INTEGRATED COLLECTOR

(71) Applicant: Bryan Hurley, Sulphur Springs, TX (US)

(72) Inventor: Bryan Hurley, Sulphur Springs, TX (US)

(21) Appl. No.: 13/844,438

(22) Filed: Mar. 15, 2013

(51) Int. Cl. B01D 45/08; F23G 7/08

(52) U.S. Cl. CPC B01D 45/08; F23G 7/085
USPC 431/253; 431/202; 55/462; 96/416

(57) ABSTRACT

A system for removing liquids from a fluid stream having a mixture of gas and liquid phase components comprises a flare stack riser configured to couple to a gas flare module. A liquid collector has an input port, an internal cavity, and an output port. The input port is configured to receive a fluid stream, the fluid stream comprising gas and entrained liquid. The input port being further configured to direct the fluid stream into the internal cavity. The internal cavity being configured to separate at least a portion of the entrained liquid from the fluid stream and to permit the gas to exit through the output port. The output port being formed integrally with the flare stack riser.

### TECHNICAL FIELD

The present invention relates generally to the field of natural resource extraction and, more particularly, to a flare stack with integrated collector.

### BACKGROUND

Modern natural resource extraction typically includes extraction of resources in a wide variety of phases, including liquid, gas, solid, or a mixture of components in various phases. Additionally, multiple steps to prepare and exploit extraction targets sometimes include capture and/or venting of undesirable or otherwise excess fluid streams. Such fluid streams commonly include a mixture of both gas and liquid.

In many cases, it is convenient and environmentally preferable to burn excess gas in a gas flare. However, liquid in the fluid stream causes problems both in maintaining a steady gas stream and in causing potentially unsafe burn conditions. Typical gas flares require the fluid stream be prepared by removing as much entrained liquid as possible.

Portable gas flares have become useful, especially for exploration of smaller or remote installations. However, typical gas flares are often too cumbersome to serve as effective portable gas flares. Some gas flares are suitably portable, such as by trailer, for example, but the construction that makes the flares portable also requires a separate liquid collector. As such, it has become common to require both a portable gas flare and a portable liquid collector, increasing the costs of the extraction.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

In one embodiment, a system for removing liquids from a fluid stream having a mixture of gas and liquid phase components comprises a flare stack riser configured to couple to a gas flare module. A liquid collector has an input port, an internal cavity, and an output port. The input port being configured to receive a fluid stream, the fluid stream comprising gas and entrained liquid. The input port being further configured to direct the fluid stream into the internal cavity. The internal cavity being configured to separate at least a portion of the entrained liquid from the fluid stream and to permit the gas to exit through the output port. The output port being formed integrally with the flare stack riser.

In one embodiment, the input port is configured with an s-shape. In one embodiment, the input port further comprises a flow director, the flow director being configured to cause the gas flow to enter the internal cavity around a circumference of the internal cavity. In one embodiment, the system further comprises a viewport, the viewport being configured to allow visual inspection of a level of liquid in the internal cavity. In one embodiment, the system further comprises a drain port for removing liquid from the internal cavity. In one embodiment, the system further comprises a baffle inside the internal cavity, the baffle being configured to assisting with separating the liquid from the fluid stream. In one embodiment, the output port is welded to the flare stack riser. In one embodiment, the system further comprises a gas flare module coupled to the flare stack riser. In one embodiment, the system further comprises a support structure coupled to the gas flare module and the flare stack riser.

In one embodiment, a portable gas burner system comprises a support structure. A gas flare module couples to the support structure. A flare stack riser couples to the a gas flare module and the support structure. A liquid collector has an input port, an internal cavity, and an output port. The input port has an s-shape and is configured to receive a fluid stream, the fluid stream comprising gas and entrained liquid. The input port being further configured to direct the fluid stream into the internal cavity. The internal cavity is configured to separate at least a portion of the entrained liquid from the fluid stream and to permit the gas to exit through the output port. The output port is welded to the flare stack riser.

In one embodiment, the input port is further configured to direct the fluid stream into the internal cavity at an angle. In one embodiment, the internal cavity further comprises a baffle inside the internal cavity, the baffle being configured to assist with separating the liquid from the fluid stream.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 is a high-level block diagram showing a gas flare system with a flare stack with integrated collector accordance with one embodiment;

FIG. 2 is a block diagram showing a flare stack with integrated collector accordance with one embodiment;

FIG. 3 is a block diagram showing a portion of a flare stack with integrated collector in accordance with one embodiment;

FIG. 4 is a block diagram showing an integrated collector in accordance with one embodiment; and

FIG. 5 is a block diagram showing a portable flare stack with integrated collector in accordance with one embodiment.

### DETAILED DESCRIPTION

The particular values and configurations discussed in these non-limiting examples can be varied and are cited merely to illustrate at least one embodiment and are not intended to limit the scope of the invention. In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail.

Referring now to the drawings, FIG. 1 is a high-level block diagram illustrating certain components of a gas flare system 100 having a flare stack with integrated collector. Generally, system 100 receives a fluid comprising gas and entrained liquids from a variety of sources, shown as feeders 102. In the illustrated embodiment, feeders 102 feed the fluid into one or more flare headers 104. The one or more flare headers 104 direct the fluid through a conduit 106 that feeds the liquid into the flare stack base 110.

In the illustrated embodiment, system 100 includes a flare stack comprising a flare stack base 110, one or more risers 120, 140, an integrated collector 130, and a flaring module 150. In one embodiment, conduit 106 feeds the fluid directly to collector 130.

In one embodiment, flare stack base 110 is a portable trailer. In one embodiment, flare stack base 110 is a manifold to receive connections to conduit 106. In one embodiment, flare stack base 110 includes a scaffold or other support structure configured to raise and/or support the flare stack in a vertical position.

In the illustrated embodiment, flare stack base 110 couples to a riser 120 through a conduit 112. Generally, conduit 112 delivers fluid to riser 120 from flare stack base 110. In one embodiment, riser 120 is a single fluid conduit, configured to direct the fluid flow upward in a vertical direction. In one embodiment, riser 120 is a plurality of fluid conduits. As described above, in one embodiment, riser 120 is omitted. As used herein, a conduit includes a pipe, hose, or other device to direct the flow of a fluid, whether pressurized or unpressurized, and whether fully enclosed or partially open. Generally, the conduits in preferred embodiments are suitable for ground equipment operations associated with oil and/or gas extraction.

In the illustrated embodiment, riser 120 couples to a collector 130. In the illustrated embodiment, riser 120 couples to collector 130 through a conduit 122. In one embodiment, conduit 112 couples to an input port of collector 130, described in more detail below. Generally, collector 130 is integrally formed with the one or more risers of the flame stack. In some embodiments, especially embodiments with multiple risers, collector 130 can be configured as an integrally coupled to only the riser that couples to an output port side of collector 130. In one embodiment, collector 130 is integrally formed with the riser 120 coupled to an input port side of collector 130 as well as the riser 140 coupled to an output port side of collector 130.

In an embodiment where collector 130 is integrally formed with riser 120, conduit 122 can be configured as a welded connection. Similarly, in an embodiment where collector 130 is integrally formed with riser 140, conduit 132 can be configured as a welded connection. In a preferred embodiment, conduit 122 (and conduit 132) is not a flange or otherwise removable connection. In one embodiment, collector 130 is integrally coupled to at least one of riser 120 and riser 140.

In the illustrated embodiment, collector 130 is further configured as a fluid collector. One skilled in the art will understand that fluid collectors are sometimes referred to in the field as a “knock-out drums.” For ease of discussion, the fluid collectors described herein will be described as “collectors” or “fluid collectors.” One skilled in the art will appreciate that there are a wide variety of specific configurations of fluid collectors that can be employed.

In the illustrated embodiment, risers 140 couple to a flaring module 150 through a coupling 142. Generally, flaring module 150 is configured to burn gas delivered from risers 140. One skilled in the art will appreciate that there are a variety of suitable mechanisms for configuring a flaring module 150.

Generally, a fluid with gas and entrained liquids is received at flare headers 104 (from a variety of sources). System 100 delivers the fluid to the flare stack at the flare stack base 110, which in one embodiment is a portable support structure. The flare stack base 110 passes the fluid to a riser 120, which feeds the fluid into a collector 130.

Generally, in one embodiment, collector 130 is configured to remove, or at least to assist in the removal of entrained liquids from within the fluid, resulting in a fluid stream that is substantially burnable gas. One skilled in the art will appreciate that the specific performance requirements for an operational collector 130 can be based on the particular environment in which system 100 is employed.

Generally, collector 130 delivers a fluid to riser 140 that, in one embodiment, is substantially burnable gas. In one embodiment, collector 130 is configured to deliver a fluid to riser 140 that contains a percentage of entrained liquids that is consistent with appropriate regulatory, safety, or other suitable requirements. One skilled in the art will appreciate that a fluid completely free of entrained liquid is typically cost-prohibitive for most applications.

As shown in the illustrated embodiment, risers 140 deliver the reduced-liquid fluid to a flaring module 150 for burn off. Thus, one skilled in the art will appreciate that the disclosed embodiments provide a flare stack with an integrated collector. So configured, the flare stack can be easily portable while operating more safely than typical flare stacks that require a detached collector or other separate fluid processing.

FIG. 2 is a block diagram showing a flare stack 200 with integrated collector accordance with one embodiment. In the illustrated embodiment, flare stack 200 includes an integrated collector. As described above, in one embodiment, the collector is configured to reduce the amount of entrained liquids in a fluid stream.

In the illustrated embodiment, flare stack 200 includes an input port 210, a drum 230 that defines an internal cavity, and an output port 236. In the illustrated embodiment, output port 236 is contiguous with a riser, such as riser 140 of FIG. 1, for example. In one embodiment, output port 236 is welded to drum 230 to provide an outlet for the fluid stream.

In the illustrated embodiment, flare stack 200 includes an input port 210. In the illustrated embodiment, input port 210 is configured to receive a fluid stream at an inlet 212, and to deliver the received fluid stream to drum 230. In the illustrated embodiment, input port 210 has an s-shape and couples to drum 230 at a variety of support struts 214. In one embodiment, support struts 214 also couple a drum outer surface 234 to a support structure 242. One skilled in the art will appreciate that the s-shape of input port 210 can be helpful in reducing fluid stream velocity, which can assist in removing entrained liquids.

As described in more detail below, input port 210 can be configured with a flow diverter 216. In one embodiment, flow diverter 216 is configured to direct the flow of the fluid stream along the curvature of the inside circumference of the drum 230. In one embodiment, flow diverter 216 is configured to direct the flow of the fluid into drum 230 so as to create a cyclone effect, described in more detail below. In one embodiment, the cyclone effect causes the heavier liquids to be removed from the fluid stream by the action of centrifugal force.

In the illustrated embodiment, drum 230 is configured as a vertical liquid collector. One skilled in the art will appreciate that drum 230 can be configured in various sizes to accommodate the expected performance requirements at the expected operational site. In one embodiment, drum 230 is approximately 18 inches in diameter and 10 feet in height. In one embodiment, the flare stack is about 60 feet tall, inclusive of the collector, risers, and flare module.

In the illustrated embodiment, drum 230 is configured with a bottom 232 resting on and supported by a plate 240. In one embodiment, plate 240 is configured to rest on the ground. In an alternate embodiment, plate 240 is configured to elevate drum 230 off of the ground. In one embodiment, plate 240 couples to a support structure 242.

In the illustrated embodiment, drum 230 includes two sight glasses 250. In one embodiment, sight glass 250 is configured to allow visual inspection of the inside chamber of drum 230. In particular, in one embodiment, sight glass 250 is configured to allow a user to determine an approximate level of fluid inside drum 230.

In the illustrated embodiment, drum 230 also includes a drainage port 252. In one embodiment, drainage port 252 is configured to allow a user to drain liquids (or fluids) from inside of drum 230. One skilled in the art will appreciate that there are a variety of mechanisms suitable for draining captured liquids from drum 230.

Thus, flare stack 200 can be configured with a liquid collector that is an integral part of flare stack 200, providing a reduction of liquids trapped in the gas stream. In one embodiment, the vertical drum 230 decreases flow velocity, allowing the entrained liquids to settle out. In one embodiment, the diverter 216 creates a cyclone effect causing the heavier liquids to be removed using centrifugal force. In one embodiment, a sight glass 250 informs the operator of accumulated liquid, which can be drained using a port 252 located at or near the base of the drum 230.

Generally, flare stack 200 can be employed in a variety of oil and gas extraction sites. In one embodiment, especially for embodiments intended for user in sites wherein the fluid stream is expected to contain hydrogen sulfide within the gas stream, system 200 is constructed using NACE (National Association of Corrosion Engineers) approved materials.

FIG. 3 is a block diagram showing a portion of a flare stack with integrated collector in accordance with one embodiment. Specifically, FIG. 3 illustrates an input port 300. In the illustrated embodiment, input port 300 includes an inlet 310, body 320, and outlet 330. In the illustrated embodiment, inlet 310, body 320, and outlet 330 together form an s-shape.

In the illustrated embodiment, inlet 310 includes a connection point 312. Generally, connection point 312 is configured to receive a conduit configured to deliver a fluid having gas and entrained liquids. One skilled in the art will appreciate that there are a wide variety of suitable mechanisms to configure connection point 312.

Inlet 310 couples to a body 320. In the illustrated embodiment, body 320 couples to a drum (shown partially) in a fixed position, through a plurality of guides 322. In the illustrated embodiment, body 320 delivers received fluid stream to a collection drum through outlet 330.

In the illustrated embodiment, outlet 330 includes an endcap 332 and a diverter 334. Generally, in one embodiment, endcap 332 and diverter 334 are together configured to direct the fluid flow inside the collection drum so as to create a cyclone or vortex effect. One skilled in the art will appreciate that varying the angle of diverter 334 can change the effect of the vortex. One skilled in the art will also appreciate that changing the dimensions of the drum can also change the effect of the vortex as well as other fluid characteristics such as dwell time.

In one embodiment, diverter 334 redirects the fluid stream down (in a vertical direction) and to the side at a 45 degree angle. In one embodiment, this angle is consistent with the side wall of the collection drum. In one embodiment, this angle is sufficient to cause a vortex to form within the collection drum. In one embodiment, diverter 334 (and/or endcap 332) can be fabricated using several methods, including adapting pre-manufactured elbows of fabricated components.

FIG. 4 is a block diagram showing an integrated collector 400 in accordance with one embodiment. In the illustrated embodiment, collector 400 receives a fluid stream 402 through an input port 410. Stream 402 passes through diverter 412, which directs stream 402 into drum 422 as a stream 440.

In the illustrated embodiment, stream 440 passes along a side wall 420 of drum 422, moving towards a bottom of drum 422. Stream 440 becomes stream 442, which separates liquids into stream 442B and gas and liquit into stream 442A. As the fluid travels around the inside of drum 422, the stream becomes stream 444, which separates liquids into stream 444B and gas and liquid into stream 444A.

As shown, the fluid passes within drum 422, eventually becoming mostly gas stream 446 and then substantially gas stream 448. As such, in one embodiment, the internal cavity of drum 422 can be configured to separate at least a portion of the entrained liquid from the fluid stream and to permit the gas to exit through the output port. In the illustrated embodiment, stream 448 passes through an outlet port 426 of a top part 424 of drum 422, becoming a processed stream 450, headed to a flaring module.

In the illustrated embodiment, drum 422 includes a plurality of baffles 452. One skilled in the art will appreciate that baffles 452 can be configured in a variety of known ways, to assist in the removal of entrained liquids from the fluid stream. In one embodiment, drum 422 includes no baffles 452.

As described above, the disclosed embodiments can be configured for deployment on a portable system. FIG. 5 is a block diagram showing a portable flare stack with integrated collector in accordance with one embodiment. In the illustrated embodiment, portable flare stack 500 includes a flaring module 510, a riser 520, and an integrated collector 530.

As shown, portable flare stack 500 also includes a pivot coupling 540, which can be configured to provide a pivot point, around which flare stack 500 can be rotated to move back and forth between a horizontal position (for transport) and a vertical position (for operation). So configured, flare stack 500 can be conveniently mounted to a trailer or other movable flare stack base, and moved to a ground location convenient for the user.

Accordingly, the disclosed embodiments provide numerous advantages over other methods and systems. For example, the disclosed embodiments provide an integrated collector on a flare stack, which improves portability of the flare stack. In one embodiment, the disclosed embodiments can be configured for portability on a single trailer, which reduces costs and set up time as compared to previous systems and methods.

Further, the disclosed embodiments can be configured to reduce costs associated with gas flaring by providing a portable flare stack with integrated collector that can be delivered as a single unit to an operational site. The flare stack with integrated collector can be constructed from lightweight or otherwise selected materials for improving the portability of the flare stack. The disclosed embodiments can also reduce costs by eliminating the need for a separate installation of a fluid collector, which reduces transport and maintenance costs, among other costs.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A system for removing liquids from a fluid stream having a mixture of gas and liquid phase components, the system comprising:
a flare stack riser configured to couple to a gas flare module;
a liquid collector having an input port, an internal cavity, and an output port;
the input port being configured to receive a fluid stream, the fluid stream comprising gas and entrained liquid;
the input port being further configured to direct the fluid stream into the internal cavity;
the internal cavity being configured to separate at least a portion of the entrained liquid from the fluid stream and to permit the gas to exit through the output port; and
the output port being formed integrally with the flare stack riser.

2. The system of claim 1, wherein the input port is configured with an s-shape.

3. The system of claim 1, wherein the input port further comprises a flow director, the flow director being configured to cause the gas flow to enter the internal cavity around a circumference of the internal cavity.

4. The system of claim 1, further comprising a viewport, the viewport being configured to allow visual inspection of a level of liquid in the internal cavity.

5. The system of claim 1, further comprising a drain port for removing liquid from the internal cavity.

6. The system of claim 1, further comprising a baffle inside the internal cavity, the baffle being configured to assist with separating the liquid from the fluid stream.

7. The system of claim 1, wherein the output port is welded to the flare stack riser.

8. The system of claim 1, further comprising a gas flare module coupled to the flare stack riser.

9. The system of claim 1, further comprising a support structure coupled to the gas flare module and the flare stack riser.

10. A portable gas burner system, comprising:
a support structure;
a gas flare module coupled to the support structure;
a flare stack riser coupled to the a gas flare module and the support structure;
a liquid collector having an input port, an internal cavity, and an output port;
the input port having an s-shape and being configured to receive a fluid stream, the fluid stream comprising gas and entrained liquid;
the input port being further configured to direct the fluid stream into the internal cavity;
the internal cavity being configured to separate at least a portion of the entrained liquid from the fluid stream and to permit the gas to exit through the output port; and
the output port being welded to the flare stack riser.

11. The system of claim 10, wherein the input port is further configured to direct the fluid stream into the internal cavity at an angle.

12. The system of claim 10, wherein the internal cavity further comprising a baffle inside the internal cavity, the baffle being configured to assist with separating the liquid from the fluid stream.
